(19) United States
(12) Patent Application Publication
(10) Pub. No.: US 2003/0156988 A1
(43) Pub. Date: Aug. 21, 2003

(54) Filament controller

(76) Inventor: Lars Moller Sondergaard, Warriewood (AU)

Correspondence Address: LADAS & PARRY, 224 SOUTH MICHIGAN AVENUE, SUITE 1200, CHICAGO, IL, 60604, US

(21) Appl. No.: 10/297,163

(22) PCT Filed: May 23, 2001
(86) PCT No.: PCT/AU01/00601

(30) Foreign Application Priority Data
Jun. 2, 2000 (AU) PR0159
Apr. 10, 2001 (AU) PR 4319

(51) Int. Cl. G01N 27/16

(52) U.S. Cl. 422/96

(57) ABSTRACT

A control device is disclosed for controlling a power supply arranged to supply electrical power to a filament (Ra), the temperature of the filament (Ra) being non-linearly dependent on power supplied to the filament (Ra). The control device is arranged to receive temperature control instructions and to control the power supply such that the temperature of the filament (Ra) is controlled in accordance with the instructions. The control device is also arranged to take into account the non-linear relationship between the filament temperature and power input into the filament (Ra) so as to control the filament temperature in accordance with the instructions. The temperature control instructions are a function of a detected change in filament temperature and the control device controls the temperature of the filament (Ra) such that the life of the filament is prolonged.

### TECHNICAL FIELD

The present invention concerns a method and an apparatus for supplying electrical power to a conducting filament.

### BACKGROUND OF THE INVENTION

A filament is generally a small-diameter conducting material which is designed to heat up when an electric current passes through it. A number of devices employ filaments. For example, incandescent lights utilise a fine thread-like filament which emits visible light when a sufficient current is passed through the filament.

Catalytic hydrocarbon gas sensors employ a filament which is resistively heated in the presence of a gas. In this case, the sensor includes a filament coated with a catalyst which reacts with a range of hydrocarbon gases at elevated temperatures. The gas-catalyst reaction is exothermic and results in additional heating of the filament. Since the resistivity of a conductor increases with temperature, the exothermic reaction causes a proportionate increase in the resistance of the filament. By accurately measuring the change in filament resistance (e.g. with a Wheatstone bridge circuit) the change in filament temperature produced by the exothermic reaction can be estimated. The change in filament temperature can in turn be used as a measure of gas concentration, since the quantity of heat produced in the exothermic reaction is related to the type and concentration of the surrounding hydrocarbon gas.

A problem with most filament devices is that the filament has a finite life and eventually fails. Although the filament itself is not usually expensive, in some cases it can be expensive to replace the filament, such as when a device using a filament is in operation at a remote location. For example, catalytic hydrocarbon gas sensors are commonly used on offshore oil rigs where it is very expensive to check or replace a filament. There is therefore a need for filaments with a greater mean time between failure (MTBF).

### SUMMARY OF THE INVENTION

A first aspect of the invention provides a control device for controlling a power supply arranged to supply electrical power to a filament, the temperature of the filament being non-linearly dependent on power supplied to the filament, wherein the control device is arranged to receive temperature control instructions and to control the power supply such that the temperature of the filament is controlled in accordance with the instructions, wherein the control device is arranged to take into account the non-linear relationship between the filament temperature and power input into the filament so as to control the filament temperature in accordance with the instructions.

The control device may include a computing device arranged to calculate the input power required to heat the filament to any one of a range of filament temperatures.

The filament is preferably a formed from a metallic conducting material. The ability to compensate for the non-linear relationship between filament temperature and input power is a feature which is not described in the prior art. The present invention is based on the inventor's recognition that there is a non-linear relationship between the power supplied to a filament and the resultant temperature of the filament. For example, it has been found that the temperature of a metallic filament is typically a logarithmic function of the power supplied to the filament. In filament controllers of the prior art, it is assumed that the filament temperature is a linear function of input power. Since prior art filament controllers do not have the capacity to compensate for the non-linear power dependence, it follows that such filament controllers are not able to change the filament temperature exactly in accordance with any given temperature control instructions. Since it is known that the resistance of a filament is a linear function of the temperature of the filament, the present invention can also be used to control the resistance of a filament in response to a temperature-induced change in resistance. Alternatively, the present invention may be used to maintain the filament temperature at a constant level in response to a fluctuating input of thermal energy into the filament.

The temperature control instructions may comprise instructing the power supply to change the filament temperature according to a predetermined mathematical function. The predetermined function may be any mathematical function, such as a linear function, an exponential function, a parabolic function, etc. The predetermined mathematical function may be dependent on a predetermined parameter. The parameter may be a property of the control device itself i.e. an “internal parameter” such as voltage, current, or filament temperature. Alternatively, the parameter may be external to the control device i.e. an “external parameter”, such as time, or the voltage or current of an external circuit. The mathematical function may be a function of more than one predetermined parameter.

In one embodiment, the control device is arranged to control the power supply to respond to a first change in filament temperature by causing a second change in filament temperature, wherein the second change in filament temperature is a linear function of the first change in filament temperature. The control device may be arranged to at least partly counteract the first change in temperature. In other words, the control device may respond to an increase or decrease in filament temperature by decreasing or increasing, respectively, the filament temperature. The first change in temperature may be an increase in temperature due to an exothermic reaction at an active filament of a gas sensor, such as a catalytic hydrocarbon gas sensor. The second change in filament temperature may partially or completely counteract the first change in filament temperature. For example, the relationship between the first and second changes in filament temperature may be a linear relationship as follows,

ΔT₂=aΔT₁ (1)

where ΔT₁ is the first change in filament temperature, ΔT₂ is the second change in filament temperature, and a is a constant of proportionality. In the case where a=−1, the control device is arranged to completely counteract the first change in filament temperature. In certain applications, it may be advantageous to only partly counteract a change in filament temperature, in which case −1<a<0.

The control device of the first aspect of the invention may be used to change the temperature of a filament, such as a filament used in an incandescent light bulb or catalytic sensor, in a controlled manner, and may be used to prolong the life of the filament. The control device may comprise software and/or hardware. The control device may prolong the life of the filament by precisely controlling the filament temperature.

The present invention may be used to accurately control the temperature of a reference filament in an instrument which compares a sensed temperature with a reference temperature. For instance, heat-seeking missiles have thermal sensors designed to detect a specific wavelength in the infra-red band. Various fixed reference sensors are conventionally used to maintain stability and repeatability. A reference filament controlled using the control device of the present invention may offer the advantage of providing a filament with a stable and programmable temperature. Such reference filaments may also have applications in gas detection instruments which make ultra-violet and infra-red measurements, and require a reference source of heat which is not affected by the presence of gas. The present invention may be used to control the temperature of the reference filament in a controlled manner, and thus enable repeatable sensitivity adjustment. Alternatively, the filament may be the active filament of a catalytic hydrocarbon gas sensor, and the control device may be arranged to control the temperature of the active filament such that unnecessary heating is prevented and the life of the filament is prolonged.

The control device of the first aspect of the invention may also be used to control thermionic emission from a filament, since thermionic emission is a temperature-dependent phenomenon. For example, the control device may be used to provide constant emission from filaments in radio valves and cathode ray tubes by controlling the temperature, and may assist with the stability and MTBF of such devices.

Accurate control of lights containing filaments is important in many applications, including aircraft instruments, and runway lighting. The present invention may be used in critical defence applications where the MTBF of lamps could be improved. The present invention may be also used to enable accurate control of the colour temperature of a light, which can be important in applications such as photography and stage lighting.

Other possible applications of the control means of the first aspect of the invention include: heater elements; thermal conductivity sensors; electric (catalytic) gas lighters; industrial safety lamps; battery chargers; and infra-red heating elements.

A second aspect of the present invention provides a gas sensor for sensing a hydrocarbon gas, comprising:

an active filament having an electrical resistivity which is indicative of a temperature of the active filament, the active filament being arranged in use to change temperature and resistivity in response to exposure to a hydrocarbon gas by catalysing an exothermic reaction in the gas, wherein the active filament temperature is non-linearly dependent on electrical and thermal power input into the active filament;

a passive filament having an electrical resistivity which is responsive to a temperature of the passive filament, the temperature of the passive filament being non-linearly dependent on electrical and thermal power input into the passive filament;

a power supply arranged to supply electrical power to the active and passive filaments such that both filaments have an elevated temperature during use;

a sensing means arranged to sense a change in active filament resistivity relative to the passive filament resistivity; and

a control device arranged to control the electrical power supplied by the power supply to the active and passive filaments, wherein the control device is further arranged to at least partly counteract any relative change in active filament resistivity as sensed by the sensing means by altering the electrical power input into the active filament;

wherein the apparatus is arranged to take into account the non-linear relationship between the active filament temperature and filament power so as to improve gas sensing accuracy.

The control device may be in accordance with the control device described in the first aspect of the invention. The sensing means may sense the change in resistivity either indirectly or directly. Preferably, the sensing means senses resistivity changes by sensing changes in electrical power consumed by the active filament, such as with a voltmeter or ammeter. This approach assumes that the active filament is operated under conditions in which there is a known relationship between filament temperature and filament resistivity. Preferably, filament temperature is directly proportional to filament resistivity. The sensing means may be in the form of a Wheatstone bridge arranged to sense changes in the resistivity of the active filament relative to the passive filament.

It is preferable that the power supply does not completely counteract the increase in temperature caused by the exothermic reaction, as the filament life will be shortened if the operating temperature is too low. For example, the control device may be arranged to reduce the temperature of the active filament by a fixed proportion of the change in temperature (e.g. 15%).

In one embodiment, the active filament is coated with a catalytic material (e.g. platinum) which catalyses an exothermic reaction when heated in the presence of a hydrocarbon gas. The passive filament is also exposed to the same hydrocarbon gas as the active filament, but does not have a catalytic coating and cannot catalyse an exothermic reaction with the gas. Since exothermic reactions do not occur at the passive filament, the only source of heat is from resistive heating. The passive and active filaments are connected in parallel with a voltage divider to form a Wheatstone bridge circuit. The sensing means comprises a voltmeter which measures an output voltage Vₒ across part of the voltage divider and the active filament. As the temperature of the active filament increases due to the exothermic reaction, the resistivity of the active filament also increases, which in turn causes an increase in the electrical power consumed by the active filament. The control device responds to the increase in Vₒ by reducing the level of power input into the active filament such that the filament temperature reduces.

Use of the present invention to control a filament in a catalytic gas sensor has been found to dramatically improve the response variations between the common paraffin hydrocarbons to less than ±10%. Prior art catalytic hydrocarbon gas sensors produce much greater variations between gases, especially with the heavier hydrocarbons.

A third aspect of the present invention provides an apparatus for supplying electrical power to a filament, the apparatus comprising a power supply and a switching means for switching the power on or off, wherein the switching means is arranged to prolong the life of the filament by switching the power supply such that the temperature of the filament is changed at a controlled rate.

It is believed that the accumulation of thermal shocks to a filament which occur as a result of rapidly switching on and off the power supply can shorten the life of the filament. The apparatus may be used to control the rate at which the temperature of a filament in an incandescent light is changed as it is switched on or off. The switching means may be arranged to change the temperature in accordance with a predetermined rate. The switching means may be arranged such that when the filament is switched on, the temperature is increased linearly over time until the power level reaches a predetermined peak level, and when the filament is switched off, the temperature is decreased in a linear manner until it reaches a predetermined temperature. The ability to linearly control the temperature of a filament also allows the optical brightness of the filament to be carefully controlled.

The switching means may include a control device which is in accordance with the control device described in the first aspect of the invention. The prior art does not take into account the fact that the temperature of a filament is a logarithmic function of the power supplied to the filament.

A fourth aspect of the present invention provides a method of controlling a power supply arranged to supply electrical power to a filament, the filament having a filament temperature which is non-linearly dependent on supplied power, whereby to heat the filament to a predetermined temperature, the method comprising the steps of:

ascertaining the input power required to heat the filament to the predetermined temperature;

controlling the power supply to compensate for the non-linear relationship between temperature and power such that the required input power is supplied to the filament.

The method may be implemented with the control means described in the first aspect of the invention.

The step of ascertaining the input power may comprise calculating the input power required to heat the filament to the predetermined temperature. For example, if the relationship between the input power and filament temperature is known, then the input power can be calculated by a processor for each predetermined temperature.

Alternatively, the step of ascertaining the input power may comprise referring to prerecorded data which correlates a range of respective filament temperatures with a range of respective input powers.

A fifth aspect of the present invention provides a method of operating an active filament in a catalytic hydrocarbon gas sensor, the sensor further including a passive filament and a power supply arranged to supply power to both filaments, the method comprising the steps of;

supplying electric power to the active and passive filaments such that they are resistively heated to at least a predetermined temperature;

at least partly counteracting any change in the temperature of the active filament resulting from exposure to the hydrocarbon gas.

The method according to the fifth aspect of the invention may be implemented with the gas sensor described in the second aspect of the invention.

A sixth aspect of the present invention provides a method of switching electrical power to a filament on or off whereby to prolong the life of the filament, comprising the step of switching an electrical power supply such that a temperature of the filament is changed at a controlled rate.

The method according to the sixth aspect of the invention may be implemented with the apparatus described in the third aspect of the invention.

Throughout this specification, unless the context requires otherwise, the word “comprise” or variations such as “comprises” or “comprising”, will be understood to imply the inclusion of a stated element or integer or group of elements or integers but not the exclusion of any other element or integer or group of elements or integers.

Embodiments of the invention will now be described, by way of example only, with reference to the accompanying drawings.

### BRIEF DESCRIPTION OF THE DRAWINGS

FIG. 1 is a circuit diagram of a catalytic sensor including a control circuit in accordance with an embodiment of the present invention.

FIG. 2 shows a plot of filament resistance versus power input into an active filament of the embodiment shown in FIG. 1.

FIG. 3 shows an example of electrical characteristics for the catalytic sensor shown in FIG. 1.

FIG. 4 shows a second example of electrical characteristics for the catalytic sensor shown in FIG. 1.

FIG. 5 is a schematic diagram of an embodiment of a control means for controlling the gas sensor shown in FIG. 1 using a voltage-controlled current source.

FIG. 6 is a schematic diagram showing a compensation stage for the control means in FIG. 5.

FIG. 7 is a schematic diagram of a second embodiment of a control means for controlling the gas sensor shown in FIG. 1 using a voltage-controlled voltage source.

FIG. 8 is a schematic diagram showing a compensation stage for the control means in FIG. 7.

### DETAILED DESCRIPTION OF THE DRAWINGS

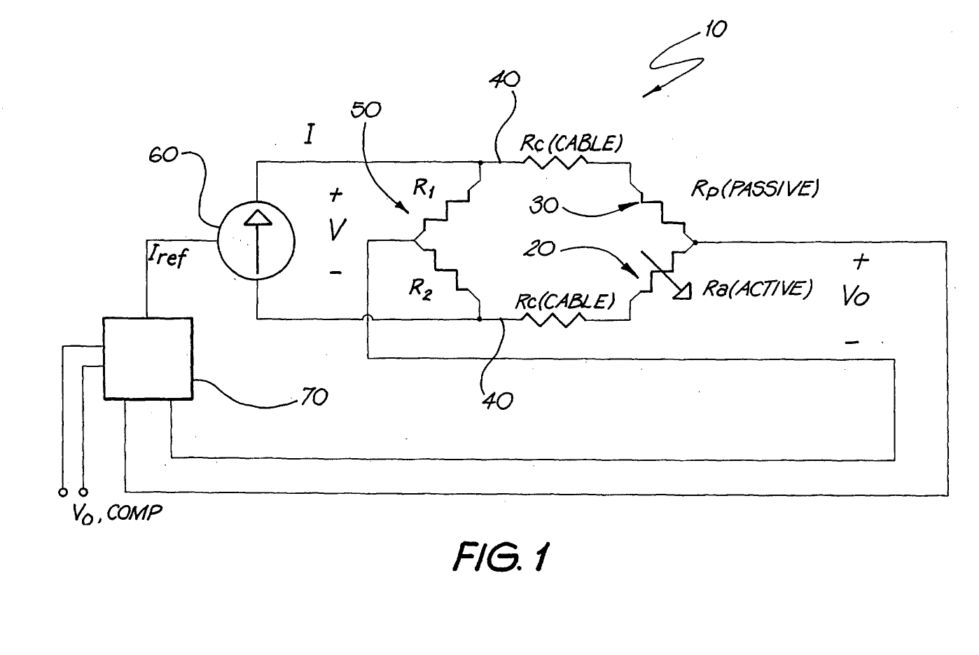

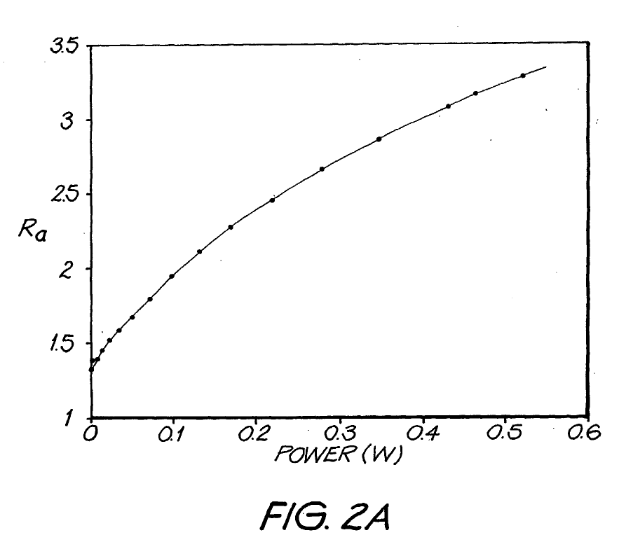

FIG. 1 shows a circuit 10 in which an active filament 20 and a passive filament are connected in a Wheatstone bridge circuit to form a catalytic sensor. The active filament 20 has a resistance Ra and is coated with a platinum catalyst, while the passive filament 30 has a resistance Rp and does not have a catalytic coating. The filaments are connected by two cables 40, each having a resistance Rc, to a voltage divider 50 arranged to form two resistors R₁ and R₂ of known resistance, where R₁=R₂. The two filaments 20, 30 are both exposed to a hydrocarbon gas of unknown concentration, while resistors R₁ and R₂ are not exposed to the gas. A power supply in the form of a current-controlled voltage source 60 supplies a current I of voltage V to the resistors R₁ and R₂ connected in series. Applying the current I to the circuit 10 causes the passive and active filaments 30, 20 to heat up due to resistive heating. The resistively heated filaments typically have a temperature of around 800° C. The presence of the catalyst causes an exothermic reaction at the surface of the active filament 20 with a hydrocarbon gas in the presence of oxygen. The lack of a catalytic coating on the passive filament 30 prevents such a reaction occurring. Consequently, a hydrocarbon gas will cause the active filament temperature to increase while the passive filament temperature remains substantially constant. In prior art catalytic sensors, the exothermic reaction may cause the temperature of the active filament to rise from 800° C. to approximately 1400° C., depending on the gas type and concentration. It is believed that the filament life is shortened by operating at such high temperatures.

The present invention avoids operating the active filament 20 at excessively high temperatures by using a control means 70 to reduce the power applied to the circuit when an exothermic reaction takes place at the active filament 20, thereby reducing the temperatures of both filaments 20, 30. The control means 70 measures the output voltage V_{O} of the Wheatstone bridge circuit and accordingly controls the current I and voltage V of the current supply to adjust the input power.

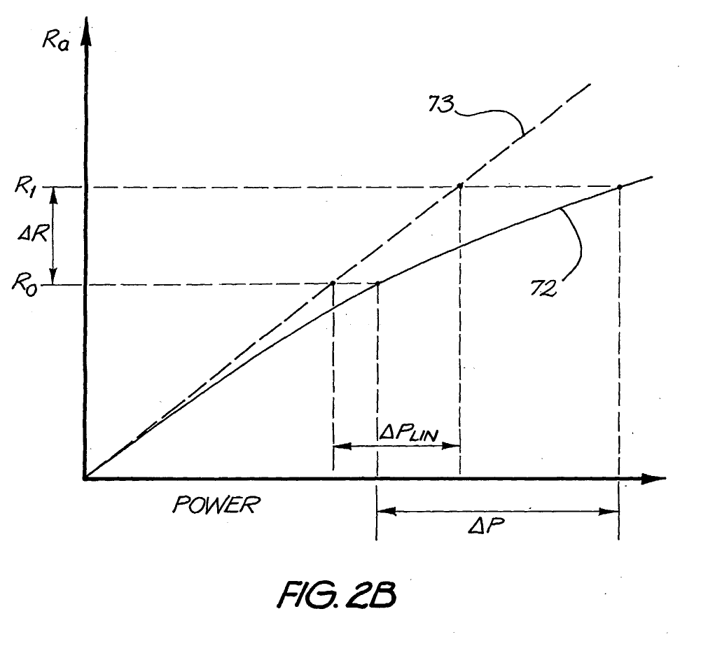

As can be seen in FIG. 2A, there is a non-linear relationship between the filament resistance and the input power. It is known that, at least within the operating range of a catalytic sensor, there is a linear relationship between filament resistance and filament temperature. It is also known that, at least within the operating range of a catalytic sensor, the filament temperature is a logarithmic function of power input into the filament. It therefore follows that filament resistance is a logarithmic function of filament power. The data points plotted in FIG. 2A have been fitted to a logarithmic curve to illustrate that the filament resistance is indeed a logarithmic function of filament power.

In order to better understand the invention, FIG. 2B shows the errors that can arise when a non-linear filament is assumed to be linear. As with FIG. 2A, FIG. 2B shows a non-linear plot 72 of active filament resistance Rₐ verses total power input into the filament (electrical plus thermal power). For comparison, dashed line 73 shows the behaviour that would be expected from a linear filament. Consider the situation in which an exothermic reaction at the active filament causes the filament resistance to increase from R₀ to R₁. In order to bring the temperature of the filament back to its original level and thereby change the filament resistance by ΔR back to R₀, it would be necessary to reduce the power input into the active filament by ΔP. The value of ΔP can then be used to estimate the detected concentration of gas. However, if the filament is assumed to behave linearly, ΔP is greater than the expected change in power ΔP_{LIN} expected for a linear filament. Thus, in this case, the amount of gas detected would be over-estimated if the filament was assumed to behave linearly.

In order for the power controller to cause a change in temperature which is a linear function of the change in temperature caused by the exothermic reaction, it is necessary for the power controller to take into account the logarithmic relationship between filament temperature and power.

The output of voltage Vₒ is a function of Ra, Rp and I:

Vₒ=I(Ra−Rp)/2 (2)

However, it is not possible to directly measure the filament resistances Ra and Rp, or the filament temperatures. This embodiment therefore uses an indirect method of ascertaining filament resistance, in which a change in the filament power is calculated from the change in output voltage Vₒ. The calculation is simplified because the exothermic reaction can only occur at the surface of the active filament, so any change in power is attributed to a change in Ra. Once the total power at the active filament is known, the value of Ra can be determined using the plot in FIG. 2B. Using this information, the power controller is designed to respond to an increase in Ra by reducing the voltage V such that Ra is reduced to a predetermined fraction of its original value.

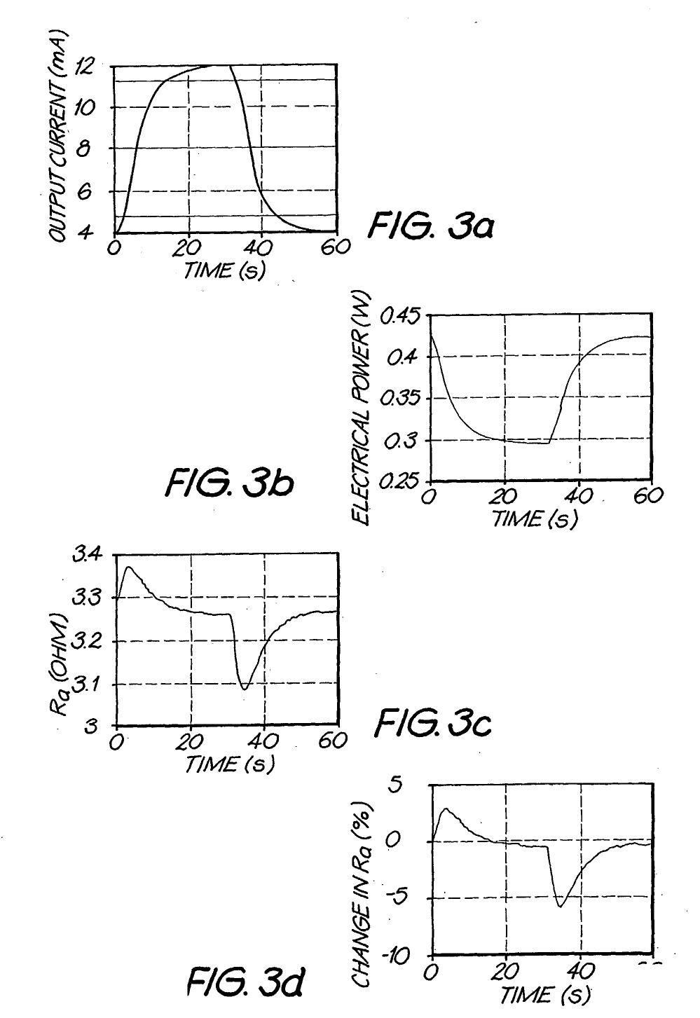

FIG. 3 shows the electrical characteristics of a catalytic sensor exposed to a methane/air mixture at a concentration of 50% of the lower explosion limit (LEL) for methane (a concentration of 5% methane in air is 100% LEL). FIGS. 3(a) and 3(b) show the changes in output current and input power as the active filament absorbs heat from an exothermic reaction with the methane. There is initially a steep increase in output current (over the period from 0-10 seconds) when the sensor is first exposed to the gas. It can be seen that the input power is reduced by the power controller in response to the increase in output current. The sensor is removed from the gas at approximately 30-32 seconds. At this point, there is a sharp fall in output current and resistance, and a corresponding increase in input power. FIGS. 3(c) and 3(d) show plots of the resistance Ra of the active filament, and the percentage change in Ra over time. It can be seen that the early reduction in electrical power over the period from 0-10 seconds arrests a sharp increase in the value of Ra, such that Ra eventually reverts to approximately its original value.

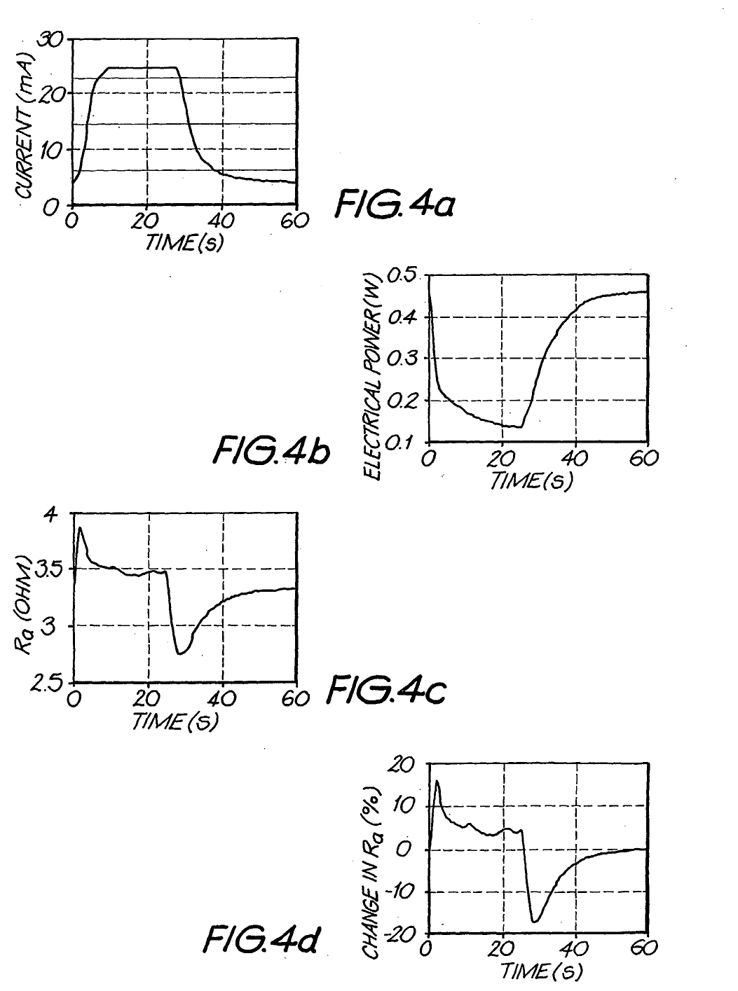

FIG. 4 is a second example in which the catalytic sensor is exposed to greater than 130% LEL C₄ H₁₀. Again, it can be seen that the electrical input power is reduced by the power controller in response to an increase in output current over the period from 0 to approximately 10 seconds. This produces a reduction in resistance over the period from approximately 2 seconds to 15 seconds. The current sharply reduces at approximately 15 seconds when the sensor is removed from the gas and the power controller responds by increasing the power.

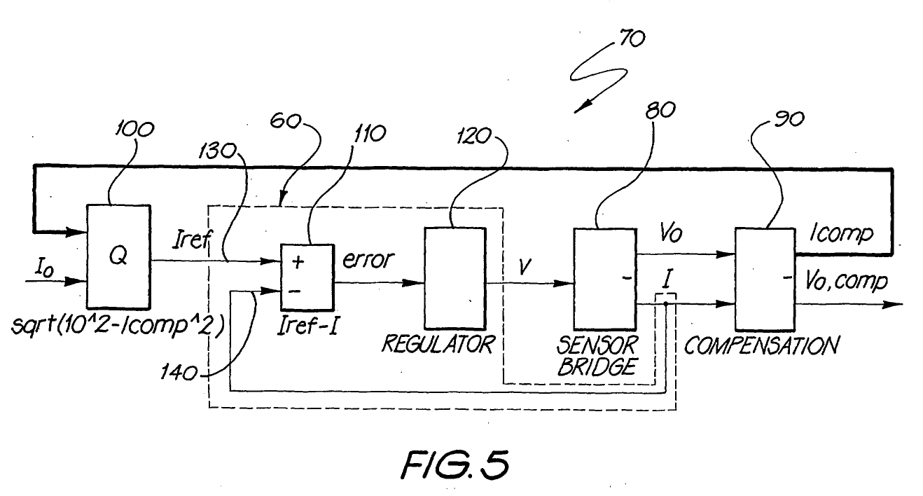

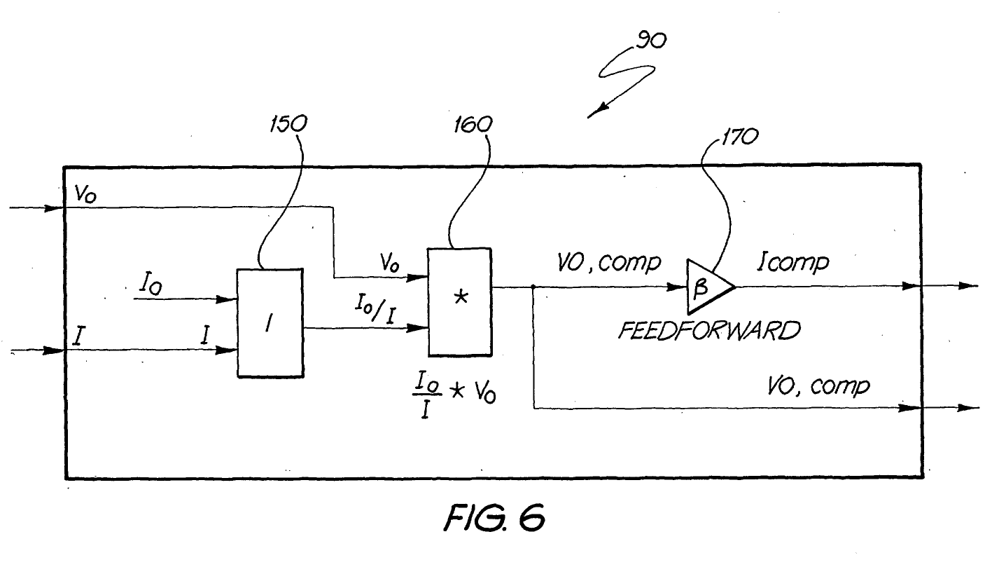

FIGS. 5 and 6 schematically show an embodiment of the control means 70, shown in FIG. 1, for controlling the current-controlled voltage source 60. This embodiment is designed to control the power supplied to the resistors Rₐ and Rₚ by adjusting the current voltage V supplied from the voltage source 60. The control means 70 controls the current voltage V supplied by the voltage source 60 by controlling a control current I_{ref}. The Wheatstone bridge of the sensor, comprising the resistors R₁, R₂, Rₐ, Rₚ, and R_{c}, are represented by the “Sensor Bridge” stage 80 in FIG. 5. As has been discussed, the resistance Rₐ increases when the sensor 10 is exposed to a hydrocarbon gas. An increase in Rₐ is detected as an increase in Vₒ. In such a case, the control means 70 responds by reducing control current I_{ref}, and therefore reducing the voltage V output by the voltage source 60. The extent to which I_{ref} is reduced is determined by a compensation stage 90 which calculates a theoretical compensation current I_{comp} based on Vo and the actual current I measured to be flowing through Rₐ and Rₚ. The calculation of I_{comp} is discussed in greater detail below. Stage “Q” 100 receives the calculated value of I_{comp} and calculates a new value of I_{ref} according to the following equation:

$${I}_{ref} = \sqrt{{I}_{0}^{2} - {I}_{comp}^{2}}$$

where I₀ is a predetermined nominal value of current. When the sensor 10 is not exposed to gas, I_{comp}=0, and I_{ref} reverts to the nominal value of current such that I_{ref}=I₀. The current-controlled voltage source 60 comprises a control stage 110 and a proportional integration regulator or “PI” regulator 120. The control stage 110 has a first input 130 for the control current I_{ref}, and a second input 140 for inputting a measurement of the current I output from the voltage source. The control stage 110 repeatedly compares the control current I_{ref} with the measured output current I of the voltage source 60. If there is any difference between I_{ref} and I, the control stage 110 calculates the difference (I_{ref}−I) and outputs the difference (shown as “error” in FIG. 5) to the PI regulator 120. The PI regulator 120 changes the output voltage V in proportion to the output of the control stage 110.

FIG. 6 schematically shows the compensation stage 90 in greater detail. As has been discussed, the gas sensor 10 uses the output voltage Vₒ as a measure of gas concentration since the value of Vₒ will reflect any change in the resistance Rₐ.

However, since the output voltage Vₒ is also determined by the current I flowing through the resistors Rₐ and Rₚ, a change in I will also cause in a change to Vₒ. In other words, a side-effect of changing the current I is that the gas concentration measurement based on Vₒ is also changed. The compensation stage 90 corrects for this effect by calculating a compensated output voltage V_{o,comp} according to the following equation:

$${V}_{o , comp} = {V}_{o} * \frac{{I}_{0}}{I}$$

The value of V_{o,comp} is not affected by changes in I but is porportional to Rₐ, and can be used as a measure of gas concentration. V_{o,comp} is calculated within the compensation stage 90 by a dividing stage 150, which calculates I₀/I, and a multiplier stage 160, which multiplies Vₒ with the output of the dividing stage 150, to produce Vo*I₀/I. The value of V_{o,comp} is passed to an amplifier 170 with a preset gain β which outputs the compensation current I_{comp}.

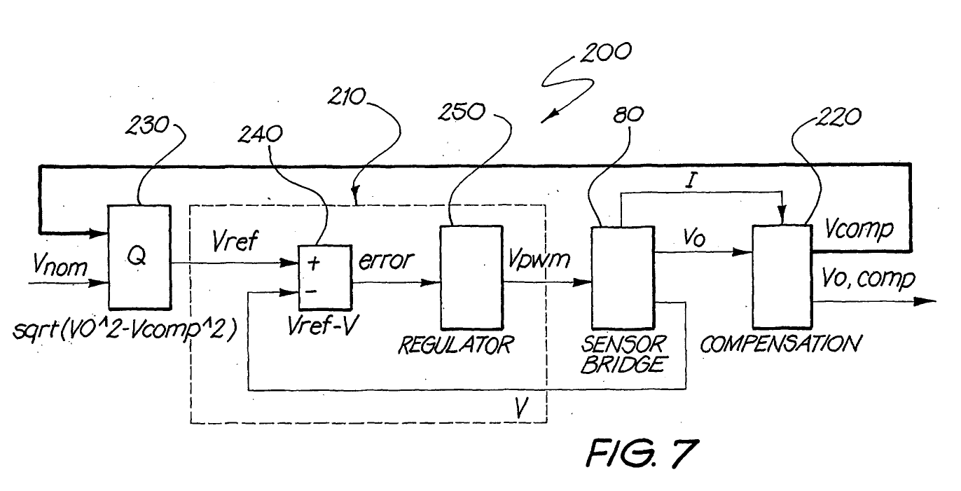

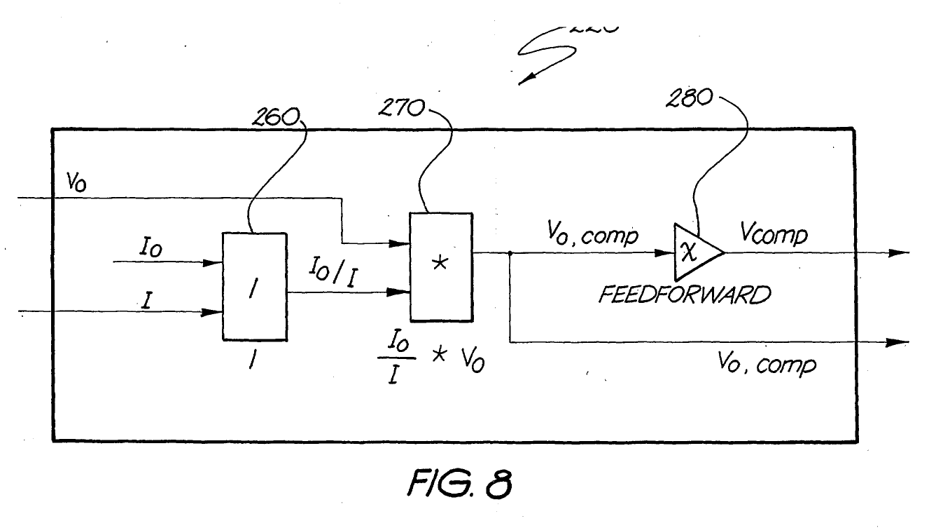

A second embodiment of a control means 200 will now be described with reference to FIGS. 7 and 8. Unlike the embodiment shown in FIGS. 5 and 6, the control means 200 shown in FIGS. 7 and 8 is designed to control a voltage-controlled voltage source 210. The output voltage V_{pwm} of the voltage source 210 is controlled with a control voltage V_{ref} generated by the control means 200. The Wheatstone bridge of the sensor, comprising the resistors R₁, R₂, Rₐ, Rₚ, and R_{c}, is again represented by the “Sensor Bridge” stage 80 in FIG. 7. The control means counteracts a change in output voltage Vₒ by changing the control voltage V_{ref}. A compensation stage 220 repeatedly samples Vo and calculates a theoretical compensation voltage V_{comp}. The calculated value of V_{comp} is output from the compensation stage 220 to stage “Q” 230 which calculates a new value of V_{ref} according to the following equation:

$${V}_{ref} = \sqrt{{V}_{nom}^{2} - {V}_{comp}^{2}}$$

where Vₙₒₘ is a predetermined nominal value of voltage. When the gas sensor is not exposed to gas, V_{comp}=0, and V_{ref} reverts to the nominal value of voltage such that V_{ref}=Vₙₒₘ.

The voltage source 210 comprises a control stage 240 and a PI regulator 250. The control stage 240 repeatedly compares the control voltage V_{ref} with the measured output voltage V of the voltage source 210. If there is any difference between V_{ref} and V, the control stage 240 calculates the difference (V_{ref}−V) and outputs the difference (shown as “error” in FIG. 7) to the PI regulator 250. The PI regulator 250 changes the output voltage V_{pwm} in proportion to the output of the control stage 240.

FIG. 8 schematically shows the compensation stage 220 in greater detail. As with the previous embodiment, the compensation stage 220 shown in FIG. 8 corrects the measured voltage Vₒ for changes in current I by calculating a compensated output voltage V_{o,comp} according to the following equation:

$${V}_{o , comp} = {V}_{o} \frac{{I}_{0}}{I}$$

where Iₒ is a predetermined nominal value of current. The value of V_{o,comp} is not affected by changes in I but is porportional to Rₐ, and can be used as a measure of gas concentration. V_{o,comp} is calculated within the compensation stage 240 by a dividing stage 260, which calculates I₀/I, and a multiplier stage 270, which multiplies Vₒ with the output of the dividing stage 260, to produce Vo*I₀/I. The value of V_{o,comp} is passed to an amplifier 280 with a preset gain χ which outputs the compensation voltage V_{comp}.

Although the control means described here is for a gas sensor, it will be understood that similar control means may be implemented for use with various other types of filaments, such as filaments for light globes, or reference temperature filaments.

It will be appreciated by a person skilled in the art that numerous variations and/or modifications may be made to the present invention as shown in the specific embodiment without departing from the spirit or scope of the invention as broadly described. The present embodiments are therefore to be considered in all respects illustrative and not restrictive.

The claims defining the invention are as follows:

1. A control device for controlling a power supply arranged to supply electrical power to a filament, the temperature of the filament being non-linearly dependent on power supplied to the filament, wherein the control device is arranged to receive temperature control instructions and to control the power supply such that the temperature of the filament is controlled in accordance with the instructions, wherein the control device is arranged to take into account the non-linear relationship between the filament temperature and power input into the filament so as to control the filament temperature in accordance with the instructions.

2. The control device according to claim 1, wherein the control device includes a computing device arranged to calculate the input power required to heat the filament to any one of a range of filament temperatures.

3. The control device according to claim 2, wherein the computing device includes analogue circuitry.

4. The control device according to claim 2 or claim 3, wherein the computing device includes digital circuitry.

5. The control device according to any one of claims 1 to 4, wherein the temperature control instructions are a function of a detected change in filament temperature.

6. The control device according to any one of the preceding claims, wherein the control device is arranged to control the temperature of the filament such that the life of the filament is prolonged.

7. The control device according to any one of the preceding claims, wherein the temperature control instructions comprise instructions to heat the filament to a predetermined temperature, and the control device is arranged to control the power supply such that the filament is maintained at substantially the predetermined temperature.

8. The control device according to any one of the preceding claims, wherein the filament comprises an active filament in a gas sensor, the active filament being arranged to undergo a change in temperature when exposed to a hydrocarbon gas, the control device being arranged to at least partially counteract the change in temperature by altering the electrical power supplied by the power supply to the active filament.

9. The control device according to any one of claims 1 to 7, wherein the filament comprises a reference filament arranged to provide a device with a reference temperature, the control device being arranged to maintain the filament at a substantially constant temperature in accordance with the temperature control instructions.

10. The control device according to any one of claims 1 to 7, wherein the filament is arranged to undergo thermionic emission, the control device being arranged to control the temperature of the filament such that the thermionic emission is substantially constant.

11. The control device according to any one of claims 1 to 7, wherein the filament is a filament of a light globe, and the control device is arranged to control optical emissions from the filament by controlling the temperature of the filament.

12. A gas sensor for sensing a hydrocarbon gas, comprising:
an active filament having an electrical resistivity which is indicative of a temperature of the active filament, the active filament being arranged in use to change temperature and resistivity in response to exposure to a hydrocarbon gas by catalysing an exothermic reaction in the gas, wherein the active filament temperature is non-linearly dependent on electrical and thermal power input into the active filament;
a passive filament having an electrical resistivity which is responsive to a temperature of the passive filament, the temperature of the passive filament being non-linearly dependent on electrical and thermal power input into the passive filament;
a power supply arranged to supply electrical power to the active and passive filaments such that both filaments have an elevated temperature during use;
a sensing means arranged to sense a change in active filament resistivity relative to the passive filament resistivity; and
a control means arranged to control the electrical power supplied by the power supply to the active and passive filaments, wherein the control means is further arranged to at least partly counteract any relative change in active filament resistivity as sensed by the sensing means by altering the electrical power input into the active filament;
wherein the apparatus is arranged to take into account the non-linear relationship between the active filament temperature and filament power so as to improve gas sensing accuracy.

13. The gas sensor according to claim 12, wherein the control means is arranged to partially counteract the change in temperature of the active filament by causing an opposite change in filament temperature, the opposite change being a fixed proportion of the change in temperature.

14. The gas sensor according to either claim 12 or 13, wherein the active filament includes a coating of catalytic material which, when heated and exposed to a hydrocarbon gas, catalyses the exothermic reaction in the hydrocarbon gas.

15. An apparatus for supplying electrical power to a filament, the apparatus comprising a power supply and a switching means for switching the power on or off, wherein the switching means is arranged to prolong the life of the filament by switching the power supply such that the temperature of the filament is changed at a controlled rate.

16. The apparatus according to claim 15, wherein the switching means is arranged such that when the filament is switched on, the temperature is increased linearly over time until the power level reaches a predetermined peak temperature, and when the filament is switched off, the temperature is decreased in a linear manner until it reaches a predetermined temperature.

17. A method of controlling a power supply arranged to supply electrical power to a filament, the filament having a filament temperature which is non-linearly dependent on supplied power, whereby to heat the filament to a predetermined temperature, the method comprising the steps of:
ascertaining the input power required to heat the filament to the predetermined temperature;
controlling the power supply to compensate for the non-linear relationship between temperature and power such that the required input power is supplied to the filament.

18. The method according to claim 17, wherein the method is implemented with a control means in accordance with any one of claims 1-11.

19. A method of operating an active filament in a catalytic hydrocarbon gas sensor, the sensor further including a passive filament and a power supply arranged to supply power to both filaments, the method comprising the steps of:
supplying electrical power to the active and passive filaments such that they are resistively heated to at least a predetermined temperature;
at least partly counteracting any change in the temperature of the active filament resulting from exposure to the hydrocarbon gas.

20. The method according to claim 19, wherein the method is implemented with a gas sensor in accordance with any one of claim 10-12.

21. A method of switching electrical power to a filament on or off whereby to prolong the life of the filament, comprising the step of switching an electrical power supply such that a temperature of the filament is changed at a controlled rate.

22. The method according to claim 21, wherein the method is implemented with an apparatus in accordance with claim 15 or claim 16.

23. A control means substantially as hereinbefore described with reference to the accompanying drawings.

24. A sensor substantially as hereinbefore described with reference to the accompanying drawings.

25. An apparatus for supplying electrical power to a filament, the apparatus comprising a power supply and a switching means for switching the power on or off, substantially as hereinbefore described with reference to the accompany drawings.
